(19) United States
(12) Patent Application Publication
(10) Pub. No.: US 2006/0234583 A1
(43) Pub. Date: Oct. 19, 2006

(54) Article of manufacture for a fiber optic cloth

(76) Inventors: Michael Eric Grover, Aurora, CO (US); Donald Lee Burton, Aurora, CO (US)

Correspondence Address: MICHAEL ERIC GROVER, 1490 S. BAHAMA ST., AURORA, CO, 80017, US

(21) Appl. No.: 11/107,093

(22) Filed: Apr. 18, 2005

(51) Int. Cl. B32B 9/04; D04H 1/00

(52) U.S. Cl. 442/301; 2/1; 442/414; 428/913; 428/543

(57) ABSTRACT

An article of manufacture for a fiber optic cloth. This cloth is made of fiber optics. Its vary durable and will not wear if used for clothing. If the outer layers of the fiber are removed the fiber will luminate any color from a light source. This light source could be carried in your back pocket to change the color of your pants or shirt at anytime. This fabric will feel cooler because of the fiber lets air through. Its as flexible as any other fabric and will have the feel of silk. This fabric is vary soft and durable and will wear vary well. This fabric never needs ironing and can be placed in a dryer to dry. It will repel water and will not absorb liquids it is vary flexable and resist wrinkles. It also lets air move through it keeping the person cooler.

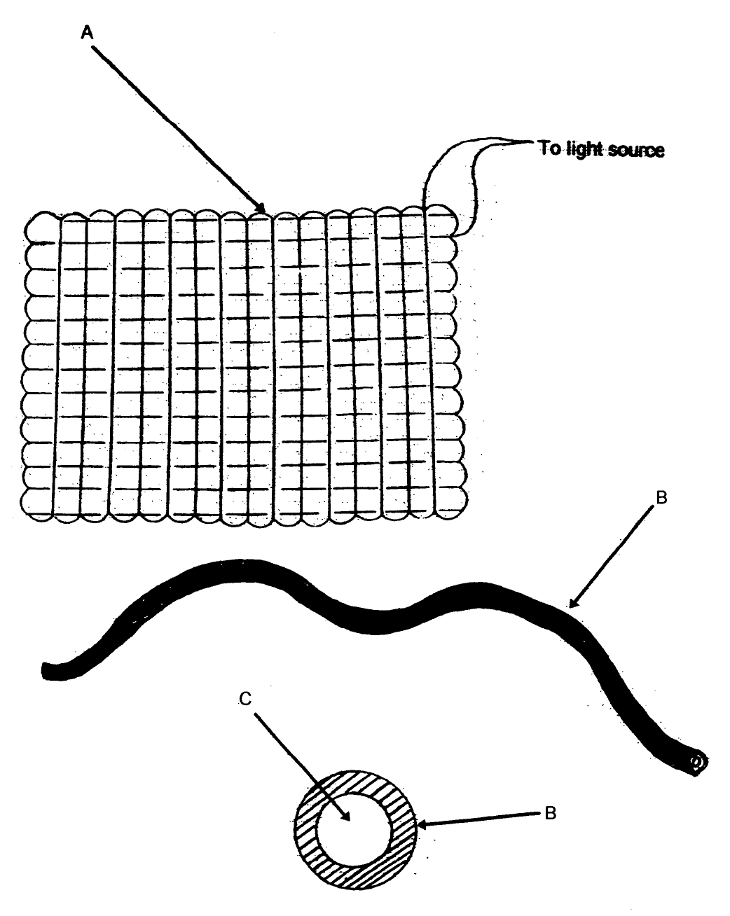

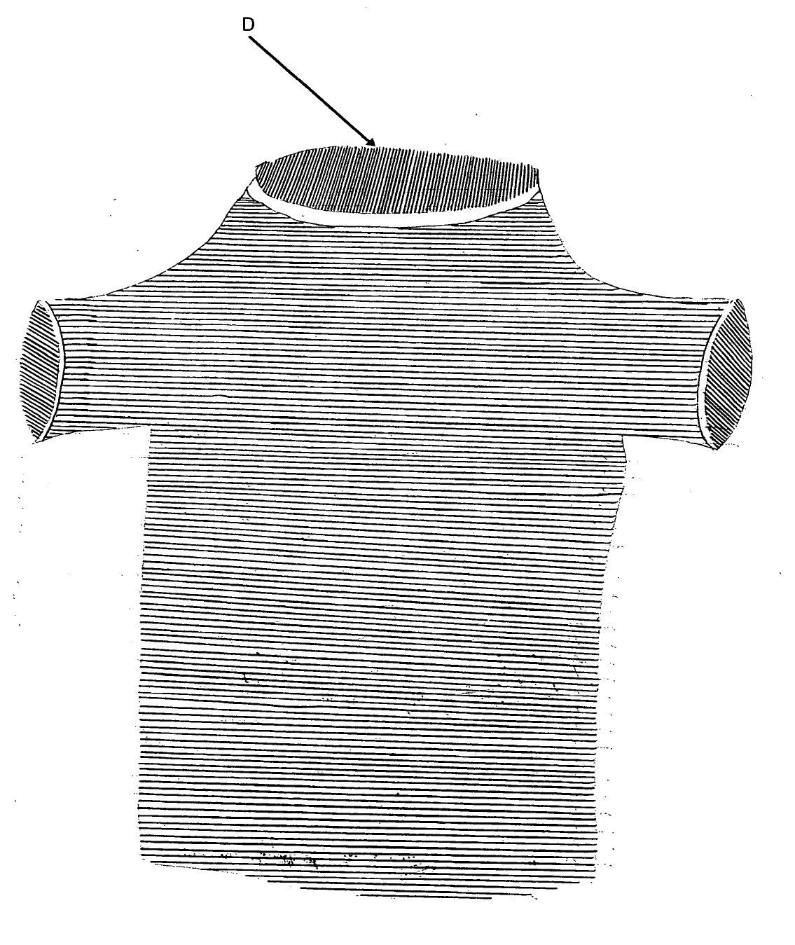

### BRIEF DESCRIPTION OF THE DRAWINGS

This is a fabric made of fiber optics.

### DRAWINGS

Looking at page 1 of 2. A. Shows fiber weaved into a cloth.

Looking at page of 1 of 2. B. Shows the fiber with a coating and C. shows the inside glass fiber.

Looking at page 2 of 2. D. is a finished product useing the fiber.

What is claimed is:

1. An artical of manufacture for a fiber optic cloth.
Its vary durable and will wear as long or longer than any other fabric.
Its cooler as air can move through it.
Its vary flexible and resists wrinkles.
Fast drying as it will not absorb any liquid.
Will not stain.
Feels vary soft simulare to silk.

2. When the outer layer of the fibers are removed the fibers will luminate any color from a light source.
You can change the color of a shirt, sofa all the way to a car at anytime.
